(19) United States
(12) Patent Application Publication
(10) Pub. No.: US 2024/0212055 A1
(43) Pub. Date: Jun. 27, 2024

(54) SYSTEMS AND METHODS FOR INSURANCE PROCESSES

(71) Applicant: SAFB Inc., Reisterstown, MD (US)

(72) Inventors: Adam Schloss, Pikesville, MD (US); Marc Philip Romm, Lewes, DE (US)

(21) Appl. No.: 18/239,737

(22) Filed: Aug. 29, 2023

Related U.S. Application Data
(60) Provisional application No. 63/402,045, filed on Aug. 29, 2022.

(51) Int. Cl. G06Q 40/08; G06F 21/60; G06K 7/14; G06N 3/0895; G06Q 30/018

(52) U.S. Cl. CPC G06Q 40/08; G06F 21/602; G06K 7/1417; G06N 3/0895; G06Q 30/0185

(57) ABSTRACT

Disclosed herein are methods and systems related to verifying insurance. An example method may comprise receiving user information associated with a user. The example method may comprise receiving a vehicle identification number (VIN) associated with a vehicle. The example method may comprise transmitting the received VIN to a VIN database. The example method may comprise receiving information about the vehicle from the VIN database. The example method may comprise creating a customized page for the user accessible by a link. The example method may comprise transmitting the link to the user. The example method may comprise receiving a selected insurance carrier associated with the user via the page accessed by the link. The example method may comprise transmitting the user information to a database associated with the selected insurance carrier. The example method may comprise receiving verification of insurance for the user from the database associated with the insurance carrier.

### BACKGROUND

### Field of the Art

The systems and methods disclosed herein are related generally to insurance verification.

### Discussion of the State of the Art

When a driver buys a car, the driver needs insurance to be in compliance with laws and/or regulations. If the driver currently has an old car, then the driver should have an existing insurance policy. A car salesman may want to verify the existing insurance and add a newly bought car to the policy. However, the current methods of verifying insurance are time consuming. What is needed is an easier and faster way to verify insurance.

### SUMMARY

The present invention is for systems and methods for verifying insurance data. The insurance data may be verified for a variety of purposes and/or for different applications, as would be apparent to a person of ordinary skill in the art, including, but not limited to during vehicle payment process, initial credit application, as part of the insurance verification process. The data may also be forwarded to an insurance agent/agency and or their rating systems for the purpose of quoting and or selling insurance to the customer partaking in the online car buying process whether the customer does or does not actually purchase a car from that digital platform. In one embodiment, the invention(s) are comprised of receiving user data, receiving VIN data, transmitting VIN data to a database, receiving vehicle information data from the database, and creating a page for further processing, transmitting a link to the page to the user, receiving user selections, and receiving verification of insurance.

### BRIEF DESCRIPTION OF THE DRAWINGS

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1 illustrates a system for verifying insurance in accordance with an exemplary embodiment of the invention.

FIG. 2 illustrates a system for verifying insurance in accordance with an exemplary embodiment of the present invention.

FIGS. 3A-3B illustrates an exemplary process for verifying insurance according to one embodiment of the invention.

FIG. 4 illustrates one embodiment of the computing architecture that supports an embodiment of the inventive disclosure.

FIG. 5 illustrates components of a system architecture that supports an embodiment of the inventive disclosure.

FIG. 6 illustrates components of a computing device that supports an embodiment of the inventive disclosure.

FIG. 7 illustrates components of a computing device that supports an embodiment of the inventive disclosure.

### DETAILED DESCRIPTION

The inventive systems and methods (hereinafter sometimes referred to more simply as “system” or “method”) described herein provide insurance verification. Specifically, the inventive systems and methods may receive user information and a vehicle identification number (VIN). The inventive systems and methods may use the VIN to retrieve vehicle information. The inventive systems and methods may receive insurance carrier information. The inventive systems and methods may use the user information, vehicle information, and insurance carrier information to receive insurance verification for the user to purchase the vehicle. The present invention may reduce computational resources and time needed to verify insurance for a vehicle purchase.

One or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural, logical, software, electrical and other changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible embodiments and in order to more fully illustrate one or more embodiments. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, method, or algorithm is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various embodiments in which, for example, functions may be executed out of order from that shown or discussed, including substantially concurrently or in reverse order, depending on the functionality involved, as would be understood by those having ordinary skill in the art.

The detailed description set forth herein in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

### Conceptual Architecture

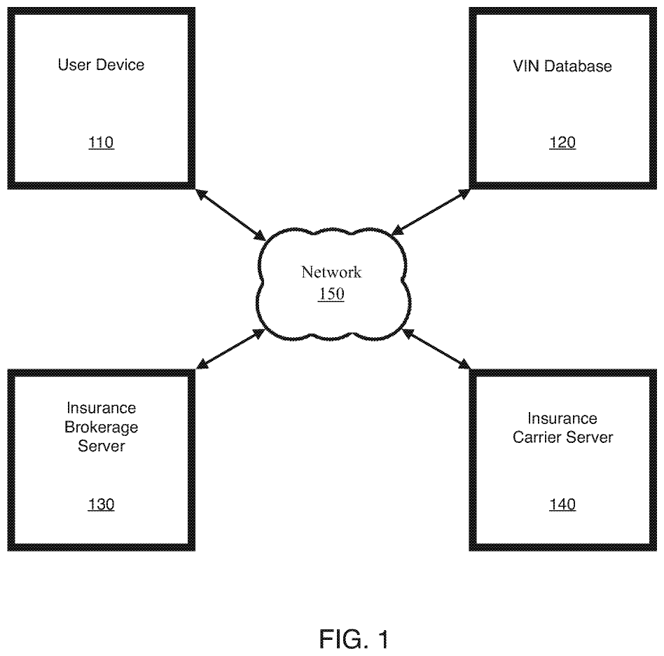

FIG. 1 illustrates an exemplary embodiment of a system for verifying insurance according to one embodiment. The system comprises one or more user device(s) 110, a vehicle identification number (VIN) database 120, one or more insurance brokerage server(s) 130, one or more insurance carrier server(s) 140, and a network 150 over which the various systems communicate and interact. The various components described herein are exemplary and for illustration purposes only and any combination or subcombination of the various components may be used as would be apparent to one of ordinary skill in the art. The system may be reorganized or consolidated, as understood by a person of ordinary skill in the art, to perform the same tasks on one or more other servers or computing devices without departing from the scope of the invention.

The user device(s) 110 may be a user device associated with a car dealership. The user device(s) 110 may be a user device associated with an employee and/or owner of the car dealership. The user device(s) 110 may be a user device associated with a potential and/or actual customer associated with the car dealership. The user device(s) 110 may comprise an application which performs the methods described herein.

The user device(s) 110 may include, generally, a computer or computing device including functionality for communicating (e.g., remotely) over a network 150. Data may be collected from user devices 110, and data requests may be initiated from each user device 110. User device(s) 110 may be a server, a desktop computer, a laptop computer, personal digital assistant (PDA), an in- or out-of-car navigation system, a smart phone or other cellular or mobile phone, or mobile gaming device, among other suitable computing devices. User devices 110 may execute one or more applications, such as a web browser (e.g., Microsoft Windows Internet Explorer, Mozilla Firefox, Apple Safari, Google Chrome, and Opera, etc.), or a dedicated application to submit user data, or to make prediction queries over a network 150.

In particular embodiments, each user device 110 may be an electronic device including hardware, software, or embedded logic components or a combination of two or more such components and capable of carrying out the appropriate functions implemented or supported by the user device 110. For example and without limitation, a user device 110 may be a desktop computer system, a notebook computer system, a netbook computer system, a handheld electronic device, or a mobile telephone. The present disclosure contemplates any user device 110. A user device 110 may enable a network user at the user device 110 to access network 150. A user device 110 may enable its user to communicate with other users at other user devices 110.

A user device 110 may have a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user device 110 may enable a user to enter a Uniform Resource Locator (URL) or other address directing the web browser to a server, and the web browser may generate a Hyper Text Transfer Protocol (HTTP) request and communicate the HTTP request to server. The server may accept the HTTP request and communicate to the user device 110 one or more Hyper Text Markup Language (HTML) files responsive to the HTTP request. The user device 110 may render a web page based on the HTML files from server for presentation to the user. The present disclosure contemplates any suitable web page files. As an example and not by way of limitation, web pages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web page encompasses one or more corresponding web page files (which a browser may use to render the web page) and vice versa, where appropriate.

The user device 110 may also include an application that is loaded onto the user device 110. The application obtains data from the network 150 and displays it to the user within the application interface.

The VIN database 120 may be hosted in one or more servers. The VIN database 120 may be hosted in a cloud computing environment. The VIN database 120 may associate VINs with associated vehicle information. The vehicle information may comprise a vehicle make (e.g., manufacturer, etc.), model, year built, color, etc. The VIN database 120 may receive a VIN. The VIN database 120 may return associated vehicle information in response to a received VIN.

The insurance brokerage server(s) 130 may comprise information about various insurance carriers. The insurance brokerage server(s) 130 may provide forms for specific insurance carriers. The insurance brokerage server(s) 130 may provide prices for specific users for specific insurance carriers. The insurance brokerage server(s) 130 may provide prices for specific users for specific insurance carriers if specific vehicles are added to specific policies. The insurance brokerage server(s) 130 may provide prices for specific users for specific insurance carriers if specific vehicles are removed from specific policies.

The insurance carrier server(s) 140 may be associated with one or more particular insurance carrier(s). The insurance carrier server(s) 140 may comprise policyholder information. The insurance carrier server(s) 140 may comprise information needed to verify a policyholder's insurance status. The insurance carrier server(s) 140 may return a verification status in response to a query about a policyholder.

Exemplary user devices are illustrated in some of the subsequent figures provided herein. This disclosure contemplates any suitable number of user devices, including computing systems taking any suitable physical form. As example and not by way of limitation, computing systems may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computing system may include one or more computer systems; be unitary or distributed; span multiple locations; span multiple machines; or reside in a cloud, which may include one or more cloud components in one or more networks. Where appropriate, one or more computing systems may perform without substantial spatial or temporal limitation one or more steps of one or more methods described or illustrated herein. As an example, and not by way of limitation, one or more computing systems may perform in real time or in batch mode one or more steps of one or more methods described or illustrated herein. One or more computing systems may perform at different times or at different locations one or more steps of one or more methods described or illustrated herein, where appropriate.

Network cloud 150 generally represents a network or collection of networks (such as the Internet or a corporate intranet, or a combination of both) over which the various components illustrated in FIG. 1 (including other components that may be necessary to execute the system described herein, as would be readily understood to a person of ordinary skill in the art). In particular embodiments, network 150 is an intranet, an extranet, a virtual private network (VPN), a local area network (LAN), a wireless LAN (WLAN), a wide area network (WAN), a metropolitan area network (MAN), a portion of the Internet, or another network 150 or a combination of two or more such networks 150. One or more links connect the systems and databases described herein to the network 150. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable network 150, and any suitable link for connecting the various systems and databases described herein.

The network 150 connects the various systems and computing devices described or referenced herein. In particular embodiments, network 150 is an intranet, an extranet, a virtual private network (VPN), a local area network (LAN), a wireless LAN (WLAN), a wide area network (WAN), a metropolitan area network (MAN), a portion of the Internet, or another network 421 or a combination of two or more such networks 150. The present disclosure contemplates any suitable network 150.

One or more links couple one or more systems, engines or devices to the network 150. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable links coupling one or more systems, engines or devices to the network 150.

In particular embodiments, each system or engine may be a unitary server or may be a distributed server spanning multiple computers or multiple datacenters. Systems, engines, or modules may be of various types, such as, for example and without limitation, web server, news server, mail server, message server, advertising server, file server, application server, exchange server, database server, or proxy server. In particular embodiments, each system, engine or module may include hardware, software, or embedded logic components or a combination of two or more such components for carrying out the appropriate functionalities implemented or supported by their respective servers. For example, a web server is generally capable of hosting websites containing web pages or particular elements of web pages. More specifically, a web server may host HTML files or other file types, or may dynamically create or constitute files upon a request, and communicate them to client/user devices or other devices in response to HTTP or other requests from client devices or other devices. A mail server is generally capable of providing electronic mail services to various client devices or other devices. A database server is generally capable of providing an interface for managing data stored in one or more data stores.

In particular embodiments, one or more data storages may be communicatively linked to one or more servers via one or more links. In particular embodiments, data storages may be used to store various types of information. In particular embodiments, the information stored in data storages may be organized according to specific data structures. In a particular embodiment, each data storage may be a relational database. Particular embodiments may provide interfaces that enable servers or clients to manage, e.g., retrieve, modify, add, or delete, the information stored in data storage.

The system may also contain other subsystems and databases, which are not illustrated in FIG. 1, but would be readily apparent to a person of ordinary skill in the art. For example, the system may include databases for storing data, storing features, storing outcomes (training sets), and storing models. Other databases and systems may be added or subtracted, as would be readily understood by a person of ordinary skill in the art, without departing from the scope of the invention.

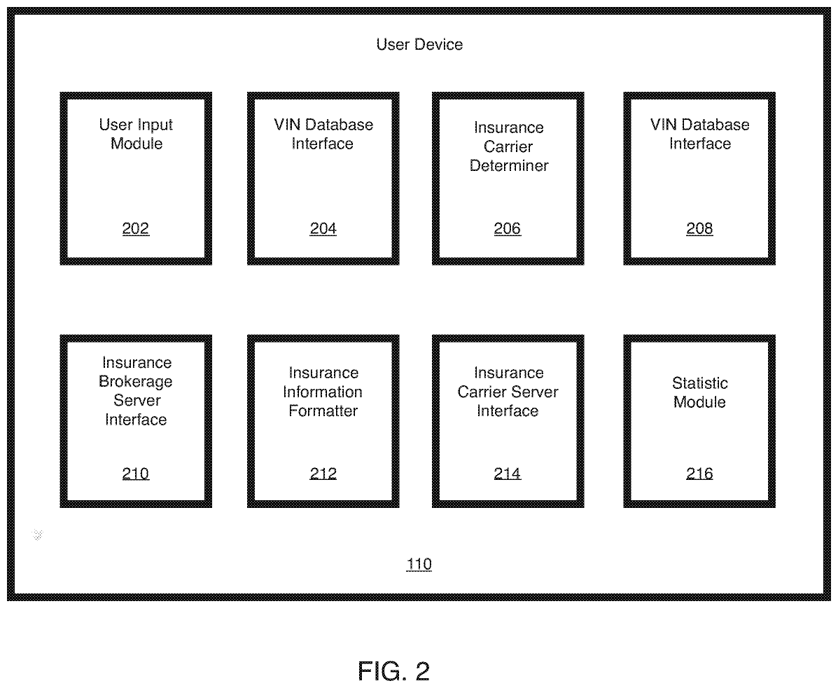

FIG. 2 illustrates an exemplary embodiment of one of the one or more user device(s) 110. The exemplary user device 110 may verify a user has insurance. The exemplary user device 103 may comprise a user input module 202, a VIN database interface 204, an insurance carrier determiner 206, an insurance brokerage server interface 208, an insurance information formatter 210, an insurance carrier server interface 212, and a statistic module 214. The various components described herein are exemplary and for illustration purposes only and any combination or subcombination of the various components may be used as would be apparent to one of ordinary skill in the art. Other systems, interfaces, modules, engines, databases, and the like, may be used, as would be readily understood by a person of ordinary skill in the art, without departing from the scope of the invention. Any system, interface, module, engine, database, and the like may be divided into a plurality of such elements for achieving the same function without departing from the scope of the invention. Any system, interface, module, engine, database, and the like may be combined or consolidated into fewer of such elements for achieving the same function without departing from the scope of the invention. All functions of the components discussed herein may be initiated manually or may be automatically initiated when the criteria necessary to trigger action have been met. As used below, sending or receiving data may be the same as sending or receiving one or more signals indicative of the sent or received data.

The user input module 202 may receive and/or interpret input from a user. The user input module 202 may receive and/or interpret input from a keyboard. The user input module 202 may receive and/or interpret input from a mouse. The user input module 202 may receive and/or interpret input from a touchscreen. The user input module 202 may receive and/or interpret input from a camera. The user input module 202 may record and/or interpret a QR code. The user input module 202 may receive input entered through an application, such as a customer relationship management (CRM) application. In other embodiments, the user information may be received in a variety of different contexts, for example, the user information may be received within the context of a credit application for a purchase transaction, wherein the user may provide user information data while completing an application. The application may be filled out electronically on an online medium, or physically at a brick and mortar store for conversion and reception by the input module 202. As described in greater detail below, the user information may be used to verify insurance data and/or the user information may be provided to third parties such as insurance agents, etc. who may use the user information to process or execute an insurance application. In one embodiment, the user information may be comprised of any data that the user may provide within the context of, for example, an application. In other embodiments, the user data may be used to generate documents, such as, but not limited to, declaration pages that may be sent to the user and/or may be sent to third parties for further processing. In other embodiments, the user information may be received in a variety of different applications, for example, the user information may be received within the context of a credit application for a purchase transaction, wherein the user may provide user information data while completing an application. As described in greater detail below, the user information may be used to verify insurance data and/or the user information may be provided to third parties such as insurance agents, etc. who may use the user information to process or execute an insurance application. In one embodiment, the user information may be comprised of any data that the user may provide within the context of, for example, an application. In other embodiments, the user data may be used to generate documents, such as, but not limited to, declaration pages that may be sent to the user and/or may be sent to third parties for further processing.

The VIN database interface 204 may receive one or more signals indicative of data from the network 150 in FIG. 1, wherein the one or more signals originated from the VIN database 120 in FIG. 1, and prepare the data in a manner suitable for consumption by other elements of the exemplary user device 110. The VIN database interface 204 may receive one or more signals indicative of data from the other elements of the exemplary user device 110 and prepare the data in a manner suitable for transmission across the network 150 and ultimate consumption by the VIN database 120. The VIN database interface 204 may transmit Application Programming Interface (API) calls to and receive API responses from the VIN database 120. The VIN database interface 204 may transmit and receive Extensible Markup Language (XML) formatted messages. The VIN database interface 204 may transmit and receive JavaScript Object Notation (JSON) formatted messages. The VIN database interface 204 may cause a VIN to be transmitted to the VIN database 120 and corresponding vehicle information (e.g., make, model, year built, color, etc.) to be received from the VIN database 120.

The insurance carrier determiner 206 may cause a link to be transmitted to a user. The insurance carrier determiner 206 may cause a link to be e-mailed to the user. The insurance carrier determiner 206 may cause a link to be texted to the user. The link may comprise a hyperlink. The link may comprise a QR code. The link may be to a page that requests the user's insurance carrier. The insurance carrier determiner 206 may receive the user's insurance carrier from the page accessible by the link.

The insurance brokerage server interface 208 may receive one or more signals indicative of data from the network 150 in FIG. 1, wherein the one or more signals originated from the insurance brokerage server(s) 130 in FIG. 1, and prepare the data in a manner suitable for consumption by other elements of the exemplary user device 110. The insurance brokerage server interface 208 may receive one or more signals indicative of data from the other elements of the exemplary user device 110 and prepare the data in a manner suitable for transmission across the network 150 and ultimate consumption by the insurance brokerage server(s) 130. The insurance brokerage server interface 208 may transmit API calls to and receive API responses from the insurance brokerage server(s) 130. The insurance brokerage server interface 208 may transmit and receive XML formatted messages. The insurance brokerage server interface 208 may transmit and receive JSON formatted messages. The insurance brokerage server interface 208 may cause user information, vehicle information, and/or insurance carrier information to be transmitted to the insurance brokerage server(s) 130 and corresponding policy information, pricing information, etc. to be received from the insurance brokerage server(s) 130.

The insurance information formatter 210 may cause information to be formatted in a manner expected by an insurance carrier server. The insurance information formatter 210 may format information based on which insurance carrier the information may be sent to. For example, the insurance information formatter 210 may format first information destined for a first insurance carrier's server according to a first standard and second information destined for a second insurance carrier's server according to a second standard, wherein the first standard may be dictated by the first insurance carrier and the second standard may be dictated by the second insurance carrier.

The insurance carrier server interface 212 may receive one or more signals indicative of data from the network 150 in FIG. 1, wherein the one or more signals originated from the insurance carrier server(s) 140 in FIG. 1, and prepare the data in a manner suitable for consumption by other elements of the exemplary user device 110. The insurance carrier server interface 212 may receive one or more signals indicative of data from the other elements of the exemplary user device 110 and prepare the data in a manner suitable for transmission across the network 150 and ultimate consumption by the insurance carrier server(s) 140. The insurance carrier server interface 212 may transmit API calls to and receive API responses from the insurance carrier server(s) 140. The insurance carrier server interface 212 may transmit and receive XML formatted messages. The insurance carrier server interface 212 may transmit and receive JSON formatted messages. The insurance carrier server interface 212 may cause user information to be transmitted to the insurance carrier server(s) 140 and insurance verification information to be received from the insurance carrier server(s) 140.

The statistic module 214 may aggregate statistics for easy browsing and/or sorting. The statistic module 214 may allow a car salesperson to browse insurance verification associated with their sales. The statistic module 214 may allow a manager to browse insurance verification associated with sales associated with car salespeople they manage.

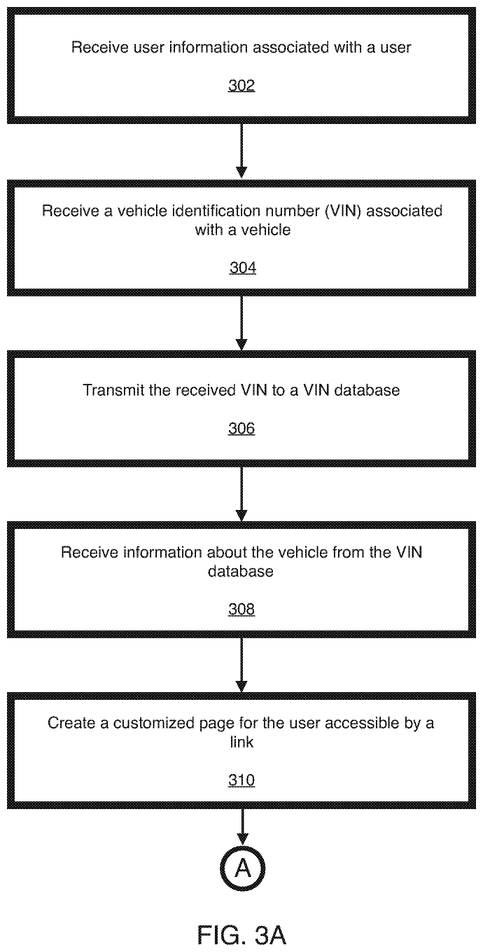

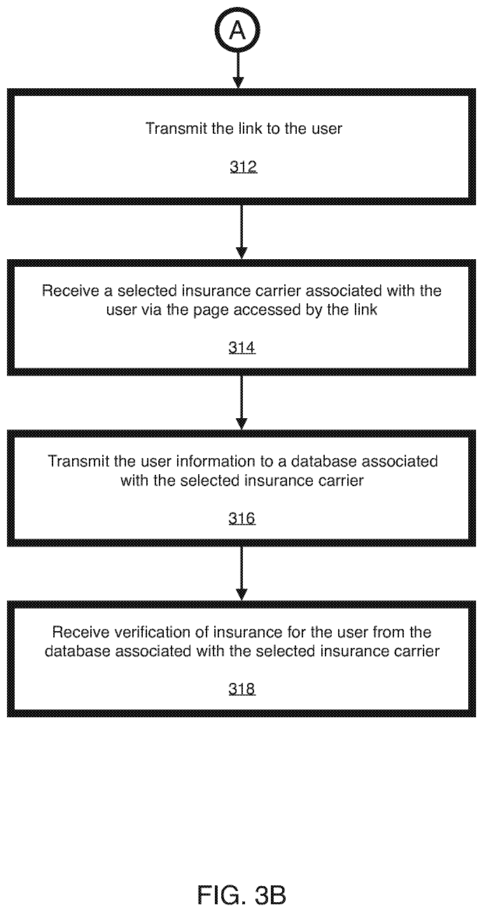

FIGS. 3A-3B illustrates an exemplary process for verifying insurance according to one embodiment of the invention. In embodiments, the method steps or techniques depicted and described herein can be performed in a processor of the user device 110 in FIG. 1, the method steps being encoded as processor-executable instructions in a non-transitory memory of the user device 110. The techniques of FIGS. 3A-3B may be implemented in an operating system kernel, in a separate user process, in a library package bound into network applications, on a specially constructed machine, on an application-specific integrated circuit (ASIC), or a field programmable gate array (FPGA). The process may comprise additional steps, fewer steps, and/or a different order of steps without departing from the scope of the invention as would be apparent to one of ordinary skill in the art.

At step 302, user information associated with a user may be received. The user information may be received from the user. The user information may be received from an employee of a car dealership. The user may be a customer of the car dealership. The user information may be received from a customer relationship management (CRM) system. In other embodiments, the user information may be received in a variety of different applications, for example, the user information may be received within the context of a credit application for a purchase transaction, wherein the user may provide user information data while completing an application. As described in greater detail below, the user information may be used to verify insurance data and/or the user information may be provided to third parties such as insurance agents, etc. who may use the user information to process or execute an insurance application. In one embodiment, the user information may be comprised of any data that the user may provide within the context of, for example, an application. In other embodiments, the user data may be used to generate documents, such as, but not limited to, declaration pages that may be sent to the user and/or may be sent to third parties for further processing.

At step 304, a vehicle identification number (VIN) associated with a vehicle may be received. The VIN may be received from manual input. The VIN may be received from a scanning of a sticker comprising the VIN. The sticker may be on the vehicle. The VIN may be received from a CRM system.

At step 306, the received VIN may be transferred to a VIN database. The VIN may be transferred using an Application Programming Interface (API) call. The VIN may be transferred using an Extensible Markup Language (XML) formatted call. The VIN may be transferred using a JavaScript Object Notation (JSON) formatted call.

At step 308, information about the vehicle may be received from the VIN database. The information about the vehicle may be received in an API response. The information about the vehicle may be received in an XML formatted response. The information about the vehicle may be received in a JSON formatted response. The information about the vehicle may comprise make, model, year built, color, etc.

At step 310, a customized page accessible by a link may be created for the user. The customized page may allow the user to select an insurance carrier. The customized page may provide options for the user to select. The customized page may allow the user to manually enter an insurance carrier.

At step 312, the link may be transmitted to the user. The link may be transmitted to the user via e-mail, text message, direct message, social media message, etc. The link may be transmitted as a hyperlink, a QR code, etc.

At step 314, a selected insurance carrier associated with the user may be received via the page accessed by the link. The selected insurance carrier may indicate an insurance carrier providing insurance to the user.

At step 316, the user information may be transmitted to a database associated with the selected insurance carrier. Transmitting the user information to a database associated with the selected insurance carrier may comprise transmitting the user information to a server comprising and/or in communication with the database associated with the selected insurance carrier. The user information may be prepared in a format expected by a server associated with the selected insurance carrier. The user information may be transferred using an API call. The user information may be transferred using an XML formatted call. The user information may be transferred using a JSON formatted call.

At step 318, verification of insurance for the user may be received from the database associated with the selected insurance carrier. Receiving verification of insurance for the user may comprise receiving verification of insurance for the user from a server comprising and/or in communication with the database associated with the selected insurance carrier. The verification of insurance for the user may be received in an API response. The verification of insurance for the user may be received in an XML formatted response. The verification of insurance for the user may be received in a JSON formatted response.

A new rate may be shown with a newly bought car added to the verified insurance policy. A new rate may be shown with a newly sold car removed from the verified insurance policy. The user information and vehicle information may be used to query other insurance carriers to allow the user to see prices of various insurance carriers. A user may select one of the other insurance carriers. Selection of one of the other insurance carriers may initiate the purchase of a policy from the selected other insurance carrier and cancellation of the previously selected policy.

A car salesperson within a dealership may view insurance verification statistics associated with sales associated with the car salesperson. A manager within the dealership may view insurance verification statistics associated with sales associated with the car salespeople under management.

In an aspect, a user may access a server associated with an online car dealership. A program executing on the server associated with the online car dealership may use the insurance verification systems and methods described herein to verify the user's insurance as part of a buying process through the online car dealership. The program may execute an insurance verification portion of the program during an initial credit application. The program may execute an insurance verification portion of the program during a vehicle selection process. The program may execute an insurance verification portion of the program during a payment selection process. The program may execute an insurance verification portion of the program during a document collection process. The program may execute an insurance verification portion of the program during an information collection process. The program may execute an insurance verification portion of the program during a conclusion of the process. The insurance verification may be provided (e.g., transmitted, sent, etc.) to or made available to the online car dealership to streamline online vehicle purchases. In one embodiment, that collected data may be used in an insurance verification process. The collected data may be forwarded to an insurance agent/agency and/or their rating systems for the purpose of quoting and/or selling insurance to the customer using the online car buying process regardless of whether the customer does or does not actually purchase a car from that digital platform. Indeed, the systems and processes described herein may be used for any application wherein an insurance verification is desired or required, including, but not limited to the applications described herein as well as others such as verifying insurance as part of a car purchase transaction, or verifying home insurance as part of a commercial transaction, insurance purchase process (wherein the process may be executed online or may be sent to an agent for further processing).

Certainly. More detailed technical aspects can be included to bolster the strength of the patent claims. Below is an updated version of the claims with additional technical specifications:

### ###Updated Patent Claims

####Independent claims
1. A computer-implemented method for verifying insurance and detecting fraud, executed on a processor of a user device comprising a CPU, RAM, and a non-transitory storage medium, the method comprising:
   a. transmitting a digitally-signed QR code to the user's device through a secure HTTPS connection, the QR code encoded with a unique session identifier;
   b. activating a native or web-based QR code scanner application on the user's device to decode said QR code and establish a WebSocket connection for real-time data transfer;
   c. utilizing Optical Character Recognition (OCR) technology to capture text-based information from a digital image of the user's driver's license, said digital image transmitted via a TLS encrypted channel;
   d. storing the received IP address and IMSI or IMEI numbers from the SIM card within an encrypted local SQLite database on the user's device;
   e. using a GPS and Cell-ID location tracking algorithm to compute the geographical coordinates of the user's device;
   f. employing a neural network-based AI algorithm to analyze aggregated user data, geolocation, and contextual information to generate content and insurance recommendations;
   g. applying k-means clustering AI algorithms to sift through user profiles and predict the most relevant insurance carriers based on a multitude of features including driving history, geographical location, and user behavior;
   h. executing the steps a-g as atomic transactions managed by a two-phase commit protocol to ensure data consistency.
2. A system comprising hardware and software components configured to execute the steps of claim 1, the system including:
   a. a multi-core processor having dedicated cores for AI computation and networking;
   b. a non-transitory memory comprising a SSD (Solid State Drive) storing processor-executable instructions encoded to perform the method of claim 1;
   c. a specialized image sensor integrated with a CMOS camera for high-fidelity image capture;
   d. a QR code scanner module implemented in Java or Swift, capable of real-time scanning and decoding;
   e. an Ethernet or Wi-Fi NIC employing MAC address filtering and packet-level encryption for enhanced security;
   f. a geolocation module comprising a GPS chipset and a mobile base station triangulation algorithm for redundant location tracking;
   g. an AI computation module built on TensorFlow or PyTorch frameworks, configured to perform real-time data analytics and prediction.
      ####Dependent claims
3. The method of claim 1, further comprising the use of multi-factor authentication algorithms like OAuth2 or SAML for secure user login.
4. The method of claim 1, wherein said OCR technology employs deep learning-based character recognition algorithms for improved accuracy.
5. The method of claim 1, wherein the geolocation tracking algorithm employs Kalman filtering to predict future user locations.
6. The method of claim 1, wherein the neural network-based AI algorithm is trained on a labeled dataset comprising at least 100,000 samples.
7. The method of claim 1, further comprising the use of Content Delivery Network (CDN) caching for low-latency delivery of contextual content.
8. The method of claim 1, wherein the k-means clustering algorithm uses cosine similarity measures to group user profiles.
9. The system of claim 2, wherein the SSD employs hardware-based full disk encryption for added security.
10. The system of claim 2, further comprising a hardware security module (HSM) for storing cryptographic keys.
11. The system of claim 2, wherein said multi-core processor is of the ARM architecture employing TrustZone technology for secure data processing.
12. The system of claim 2, wherein the Ethernet or Wi-Fi NIC is compliant with the IEEE 802.11ax standard for high-throughput networking.
13. The method of claim 1, wherein the WebSocket connection is authenticated through JSON Web Tokens (JWT).
14. The method of claim 1, wherein the data transmission and storage are compliant with the California Consumer Privacy Act (CCPA) along with General Data Protection Regulation (GDPR).

By including these additional technical specifications, the claims should be better positioned to protect the unique aspects of the invention. Always consult a qualified patent attorney for specialized advice tailored to your unique circumstances.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

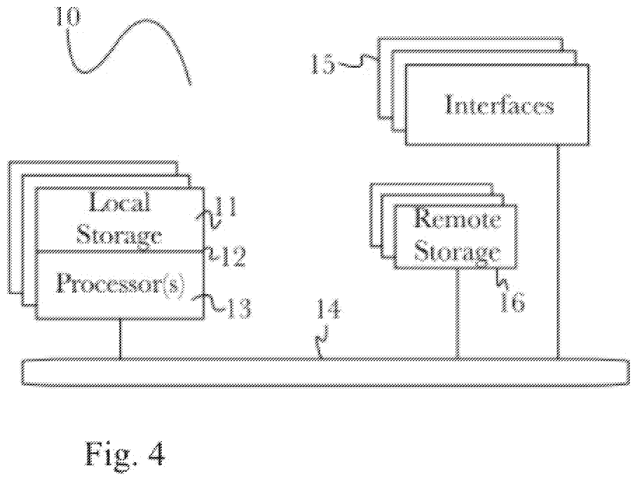

Any of the above mentioned systems, units, modules, engines, controllers, interfaces, components or the like may be and/or comprise hardware and/or software as described herein. For example, the user device 110, VIN database 120, insurance brokerage server 130, insurance carrier server 140, and subcomponents thereof may be and/or comprise computing hardware and/or software as described herein in association with FIGS. 4-7. Furthermore, any of the above mentioned systems, units, modules, engines, controllers, interfaces, components or the like may use and/or comprise an application programming interface (API) for communicating with other systems units, modules, engines, controllers, interfaces, components, or the like for obtaining and/or providing data or information.

Referring now to FIG. 4, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random-access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 4 illustrates one specific architecture for a computing device 10 for implementing one or more of the embodiments described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, single processor 13 handles communications as well as routing computations, while in other embodiments a separate dedicated communications processor may be provided. In various embodiments, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

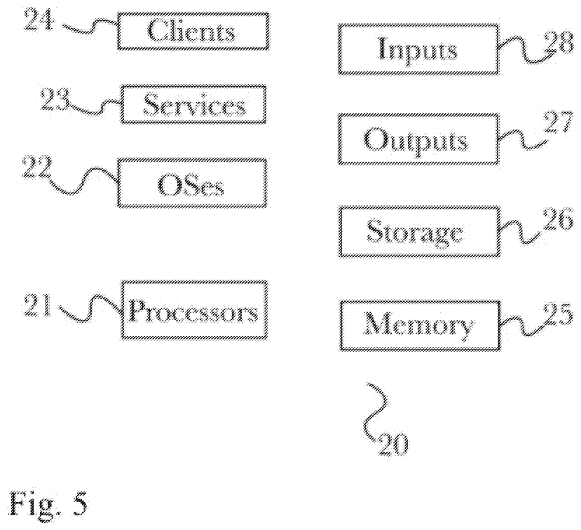

In some embodiments, systems may be implemented on a standalone computing system. Referring now to FIG. 5, there is shown a block diagram depicting a typical exemplary architecture of one or more embodiments or components thereof on a standalone computing system. Computing device 20 includes processors 21 that may run software that carry out one or more functions or applications of embodiments, such as for example a client application. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 4). Examples of storage devices 26 include flash memory, magnetic hard drive, CD-ROM, and/or the like.

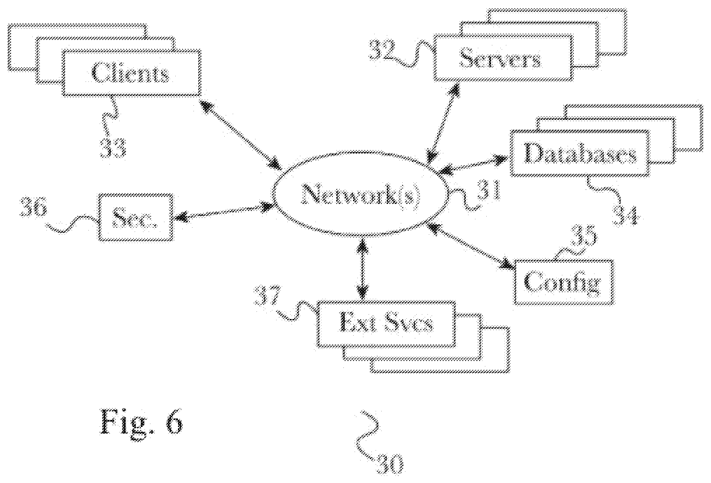

In some embodiments, systems may be implemented on a distributed computing network, such as one having any number of clients and/or servers. Referring now to FIG. 6, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 5. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in one aspect where client applications are implemented on a smartphone or other electronic device, client applications may obtain information stored in a server system 32 in the cloud or on an external service 37 deployed on one or more of a particular enterprise's or user's premises.

In some embodiments, clients 33 or servers 32 (or both) may make use of one or more specialized services or appliances that may be deployed locally or remotely across one or more networks 31. For example, one or more databases 34 may be used or referred to by one or more embodiments. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some embodiments may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments without limitation, unless a specific security 36 or configuration system 35 or approach is specifically required by the description of any specific aspect.

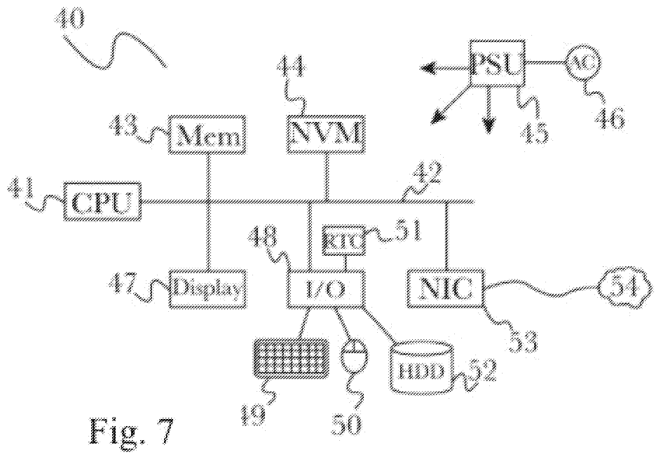

FIG. 7 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of various embodiments may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various embodiments described above. Accordingly, the present invention is defined by the claims and their equivalents.

### Additional Considerations

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for verifying insurance through the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. A computer-implemented method for verifying insurance and detecting fraud, executed on a processor of a user device comprising a CPU, RAM, and a non-transitory storage medium, the method comprising:
transmitting a digitally-signed QR code to the user's device through a secure HTTPS connection, the QR code encoded with a unique session identifier;
activating a native or web-based QR code scanner application on the user's device to decode said QR code and establish a WebSocket connection for real-time data transfer;
utilizing Optical Character Recognition (OCR) technology to capture text-based information from a digital image of the user's driver's license, said digital image transmitted via a TLS encrypted channel;
storing the received IP address and IMSI or IMEI numbers from the SIM card within an encrypted local SQLite database on the user's device;
using a GPS and Cell-ID location tracking algorithm to compute the geographical coordinates of the user's device;
employing a neural network-based AI algorithm to analyze aggregated user data, geolocation, and contextual information to generate content and insurance recommendations;
applying k-means clustering AI algorithms to sift through user profiles and predict the most relevant insurance carriers based on a multitude of features including driving history, geographical location, and user behavior; and
executing the steps a-g as atomic transactions managed by a two-phase commit protocol to ensure data consistency.

2. A system comprising hardware and software components configured to execute the steps of claim 1, the system including:
a multi-core processor having dedicated cores for AI computation and networking;
a non-transitory memory comprising a SSD (Solid State Drive) storing processor-executable instructions encoded to perform the method of claim 1;
a specialized image sensor integrated with a CMOS camera for high-fidelity image capture;
a QR code scanner module implemented in Java or Swift, capable of real-time scanning and decoding;
an Ethernet or Wi-Fi NIC employing MAC address filtering and packet-level encryption for enhanced security;
a geolocation module comprising a GPS chipset and a mobile base station triangulation algorithm for redundant location tracking; and
an AI computation module built on TensorFlow or PyTorch frameworks, configured to perform real-time data analytics and prediction.

3. The method of claim 1, further comprising the use of multi-factor authentication algorithms like OAuth2 or SAML for secure user login.

4. The method of claim 1, wherein said OCR technology employs deep learning-based character recognition algorithms for improved accuracy.

5. The method of claim 1, wherein the geolocation tracking algorithm employs Kalman filtering to predict future user locations.

6. The method of claim 1, wherein the neural network-based AI algorithm is trained on a labeled dataset comprising at least 100,000 samples.

7. The method of claim 1, further comprising the use of Content Delivery Network (CDN) caching for low-latency delivery of contextual content.

8. The method of claim 1, wherein the k-means clustering algorithm uses cosine similarity measures to group user profiles.

9. The system of claim 2, wherein the SSD employs hardware-based full disk encryption for added security.

10. The system of claim 2, further comprising a hardware security module (HSM) for storing cryptographic keys.

11. The system of claim 2, wherein said multi-core processor is of the ARM architecture employing TrustZone technology for secure data processing.

12. The system of claim 2, wherein the Ethernet or Wi-Fi NIC is compliant with the IEEE 802.11ax standard for high-throughput networking.

13. The method of claim 1, wherein the WebSocket connection is authenticated through JSON Web Tokens (JWT).

14. The method of claim 1, wherein the data transmission and storage are compliant with the California Consumer Privacy Act (CCPA) along with General Data Protection Regulation (GDPR).
